(19) United States
(12) Patent Application Publication
(10) Pub. No.: US 2006/0224913 A1
(43) Pub. Date: Oct. 5, 2006

(54) Token with relatively moving components and separator assembly thereof

(76) Inventor: Hiroshi Abe, Iwatsuki-shi (JP)

Correspondence Address: Joseph W. Price;SNELL & WILMER L.L.P., Suite 1400, 600 Anton Boulevard, Costa Mesa, CA, 92626, US

(21) Appl. No.: 11/387,516

(22) Filed: Mar. 23, 2006

(30) Foreign Application Priority Data
Apr. 1, 2005 (JP) 2005-106770

(51) Int. Cl. G06F 11/00

(52) U.S. Cl. 714/4

(57) ABSTRACT

A token having a body member with an opening therein and is configured to translate across a support surface. The token includes a sensing object movable within the opening as the body member moves across the support surface. The sensing object can be freely mounted for rotation, or pivotally mounted within the opening. The token can be formed of a plastic resin and metal sensing objects can be attached to the token. The sensing object mounted in the opening can further have detectable configurations such as openings and embedded metal to increase the characteristics that can be remotely sensed. A separator assembly having appropriate detectors or sensors can produce characteristic signals of the token which can be compared with pre-stored values to determine the authenticity of the token.

### BACKGROUND OF THE INVENTION

1. Field of the Invention

The present invention relates to tokens which can be substitutes for money used in game machines, playing spaces and the like and more particular, it relates to a low-cost resin token which can be made in a variety of different forms.

2. Description of Related Art

The term “token” used herein involves medals for game machines, tokens for operation of an automatic dispenser and any other substituted object capable of replacing monetary coin values.

Conventional tokens have been principally made of metal as shown in Japanese Laid-Open Patent Application 2100-58280. When tokens are made of metal, the variations in the form of tokens that can be produced can be limited because usable metals are limited in view of both appearance and cost. Additionally, there is a possibility that neighboring game spaces may use tokens made of the same material, and tokens of one game space may be entered into other machines. Since these tokens serve as substitute money, such an entry of tokens into other spaces is not desirable. It also leads to a possible problem of clogging in a token processor that was not designed for the specific token because tokens for use in other machines may be slightly different in thickness and diameter.

A token in which a ring core member of metal material is covered with resin has been known in Japanese Laid-Open Application 59-151283A. Tokens generally have a diameter of at most about 40 millimeters for convenience of handling. A core member should have a width of about 3 millimeters for detection. Since a token usually will roll on a guide rail, it preferably has a ring shape for ensuring the core member can be positioned to pass opposite a non-contact sensor, which can cause an increase in unneeded parts and cost. For this reason, generally the choice is to use iron which is a relatively inexpensive material for the core member, so that the variations that can be practically used are limited.

Another known token has used metal powder mixed into a resin, or a metal film with a resin laminated onto it, see EP Publication 1082921. This token can suffer from the problem of limited design variations as is the case with the first and second conventional tokens above. Finally, an IC token into which an IC tag is embedded is also known in Japanese Laid-Open Application 2003-331242A.

However, such IC tokens are still relatively expensive due to the IC tag, and hence, they cannot be readily employed.

### SUMMARY OF THE INVENTION

A first object of the present invention is to provide a token which may be produced in many different variations at a low cost.

A second object of the present invention is to provide a token which can appear heavy and of substance, but may be produced in many design variations at a low cost.

A third object of the present invention is to provide a separator assembly for separating the tokens described above.

In order to achieve the above objects, a token according to the present invention can be configured in a disc-shaped format so that the token includes a token main body having a ring-shaped path therein, and a non-contact sensing object which is movably mounted in the ring-shaped path and subject to movement by gravity.

According to the above configuration, the disc-shaped token can roll on a guide rail of a separator assembly and the non-contact sensing object can move according to the force of gravity in the ring-shaped path while the token rolls.

In other words, in the ring-shaped path, the sensing object is located almost in a position where the moving force by rolling of the token main body itself and a stationary force by gravity are exerted on the non-contact sensing object and are in balance.

The non-contact sensing object comes into a substantial stationary state in a position where the moving force by rolling of the token main body itself and a stationary force by the gravity exerted on the non-contact sensing object are in balance.

When the token rolls, the non-contact sensing object is in a relative stationary state in almost the same position. Therefore, the non-contact sensing object should be large enough to be sensed by the non-contact sensor in a position where it is in substantially a stationary state.

The non-contact sensing object can further be minimized, which leads to an advantage that relatively inexpensive materials such as brass or copper as well as iron can be used as the production material and design variations in such tokens can be increased.

In the present invention, preferably the non-contact sensing object can take the form of a characteristic part. This configuration leads to an advantage in that by forming holes, saw teeth recesses, projections and the like as the characteristic part in the non-contact sensing object, the design variations may be increased by the size, number or the like of such characteristic parts. In other words, an advantage arises in that different types of tokens may be provided in correspondence with the variations of the characteristic part.

In one embodiment of the present invention, preferably the characteristic part is a through-hole. This configuration provides an advantage of low cost production because the through-hole of the characteristic part can be formed concurrently with manufacturing of the non-contact sensing object.

In the present invention, preferably, a non-contact sensing ring is disposed on an outer circumference of a ring-shaped path. This configuration leads to an advantage in that the design variations in tokens can be further increased because the material or the like of the non-contact sensible ring can be added to the components to enable a determination of real/fake tokens.

Additionally, since the token main body can be formed with a non-contact ring that can be remotely sensed, an advantage arises in that automatic dispensing by a mechanical dispenser is enabled. In addition, the weight of the token gained by the non-contact sensible ring contributes to stabilization of the rolling speed of the token, as well as offering a luxury of a massive feeling.

In the present invention, preferably, the non-contact sensing object can be a non-contact sensible roller which rolls along the ring-shaped path. With this configuration, when the token rolls, the roller is in a substantial stationary state in a position where the rolling force exerted by the rolling of the token main body and the stationary force by gravity are in balance. That is, the roller keeps residing almost in the lowermost part of the ring-shaped path.

Therefore, by disposing the non-contact sensor so as to be opposite to this position of the roller, it is possible to sense the material and the like characteristic of the roller. Since the roller rolls in a substantially identical position, and has a minimum disc shape capable of being sensed by the non-contact sensor, it may be mass-produced at low cost by press punching or the like because only a small amount of material is used. Further, by appropriately setting the number of non-contact sensible roller, it is possible to increase the variations of token.

In the present invention, the non-contact sensing object can be a non-contact sensible rotor which is rotatable about a spindle arranged in the center of the token as a pivot point. With this configuration, when the token main body rolls, the rotor remains residing in almost a lowermost part of the ring-shaped path where the rotating force by the friction contact with the spindle and the stationary force generated by the gravity are in balance. Therefore, by disposing a non-contact sensor so as to be opposite to the passing position of the rotor, it is possible to sense the material and the characteristic of the rotor.

Since the rotor may be formed as a minimum size plate structure that can be sensed by the non-contact sensor, an advantage arises in that it may be mass-produced at low cost by press punching or the like. Furthermore, by appropriately selecting the shape of the non-contact sensible rotor, it is possible to increase the possible variations of the token.

In the present invention, preferably, the non-contact sensible roller is made of metal. Since certain metals can have a large specific gravity, the weight of the token increases, so that a token offering a weight of substance is achieved.

In addition, since such a roller can be made by a punch press method, it can be produced at a low cost.

Preferably, the present invention also provides a token separator assembly comprising, a slot through which a token is inserted, a guide rail on which the token rolls, a non-contact sensor unit disposed along the guide rail, and a determiner unit for determining a real/fake state of the token based on an output from the non-contact sensor and a comparison with predetermined stored values.

With this configuration, a token including a resin token main body in which the ring-shaped path is formed, and the non-contact sensing object, which is movable based on gravity and located in the ring-shaped path, will roll on the guide rail after passing through the token slot.

In the course of the rolling of the token main body, the sensing object remains in almost a stationary state at a predetermined position of the ring-shaped path where the rolling force exerted from the token main body and the stationary force by the gravity of the non-contact sensing object are in balance.

The non-contact sensor is disposed along the guide rail on which the token rolls opposite to the moving path of the non-contact sensing object. Therefore, when the non-contact sensor is opposite to the non-contact sensing object, a characteristic of the non-contact sensing object may be sensed and formed into a signal.

Although the token main body rolls, since the non-contact sensing object is kept in a substantially stationary state by its own weight, holes, characters and the like provided in the non-contact sensing object can be recognized by the non-contact sensor as separate signal patterns. Therefore, the form applied on the non-contact sensing object can be accurately recognized, so that whether a token is real or fake can be easily determined.

In the token separator of the present invention, preferably, the non-contact sensor is an optical sensor. In this configuration, when the non-contact sensor is an optical sensor, the width of the light used for sensing may be made narrow.

The non-contact sensing object moves together with the token main body while swinging within a predetermined range although it is almost in a stationary state according to the rolling of the token main body. Therefore, when a hole is formed in the non-contact sensing object, a range taking account of a swinging range caused by the hole can be a substantial size of the hole.

The size of the token main body is limited to a size that can be held by a user's hand. This in turn limits the non-contact sensing object within the size of the token main body, so that the size cannot be made large, and the number of holes is also limited.

When the number of holes is limited, there arise inconvenience in that variations of token designs cannot be increased. In order to shield light, however, only a width that shields the width of the light is required, so that more shielding parts can be arranged in a limited range when the width of the light is small. Therefore, more shielding parts can be arranged in a limited range, so that an advantage arises that the variations of token can be increased as much as possible.

In the present invention, the optical sensor of the token separator can include a projector and a light receiver disposed to face each other while the guide rail is interposed therebetween. In this configuration, the non-contact sensor can be a transmissive optical sensor consisting of a light projector and a light receiver that are disposed to face each other while the guide rail, i.e., the rolling path of the token is interposed therebetween.

A transmissive optical sensor is desirable because the width of light can be reduced. The transmissive optical sensor is further desirable because a laser system can form a very narrow light width at a relatively low cost.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1(A) is a front view of a token according to the first embodiment, FIG. 1(B) is a cross sectional view along the line A-A in FIG. 1 (A), FIG. 1 (C) is a front view of a token of a first embodiment in which a second main body is removed; and FIG. 1(D) is a sectional view of another example of a ring in the first embodiment;

FIG. 2(A) is a front view of a token of the second embodiment from which a second main body is removed; and FIG. 2(B) is a cross-sectional view along the line B-B in FIG. 2(A);

FIG. 3(A) is a front view of a token according to the third embodiment, FIG. 3(B) is a sectional view taken along the line C-C in FIG. 3(A), and FIG. 3(C) is a front view of the token according to the third embodiment in which the second main body is removed;

FIG. 4 is a schematic view of a token separator assembly for the first to third embodiments;

FIG. 5(A) is a front view of a token according to a fourth embodiment in a state that the second main body is removed, and FIG. 5(B) is a section view along the line D-D in FIG. 5(A);

FIG. 6 is a schematic view of a token separator assembly according to a fourth embodiment;

FIG. 7 is a sectional view along the line Y in FIG. 6; and

FIG. 8 is an explanatory view of an operation of the fourth embodiment.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

In a token having a disc shape, the token can comprise a token main body in which an opening such as a ring-shaped path is formed therein, and a non-contact sensing object can be disposed in the ring-shaped path, and positioned so that it is capable of moving based on the effects of gravity and rolling motions of the token relative to a support surface. Thus, the token has relatively moving components.

The present invention also provides a token separator assembly which can comprise a slot through which a token is inserted, a guide rail on which a token after passing through the slot will roll, a non-contact sensor unit disposed along the guide rail, and a determiner unit for determining whether the token is real or fake based on an output from the non-contact sensor unit and pre-stored reference values.

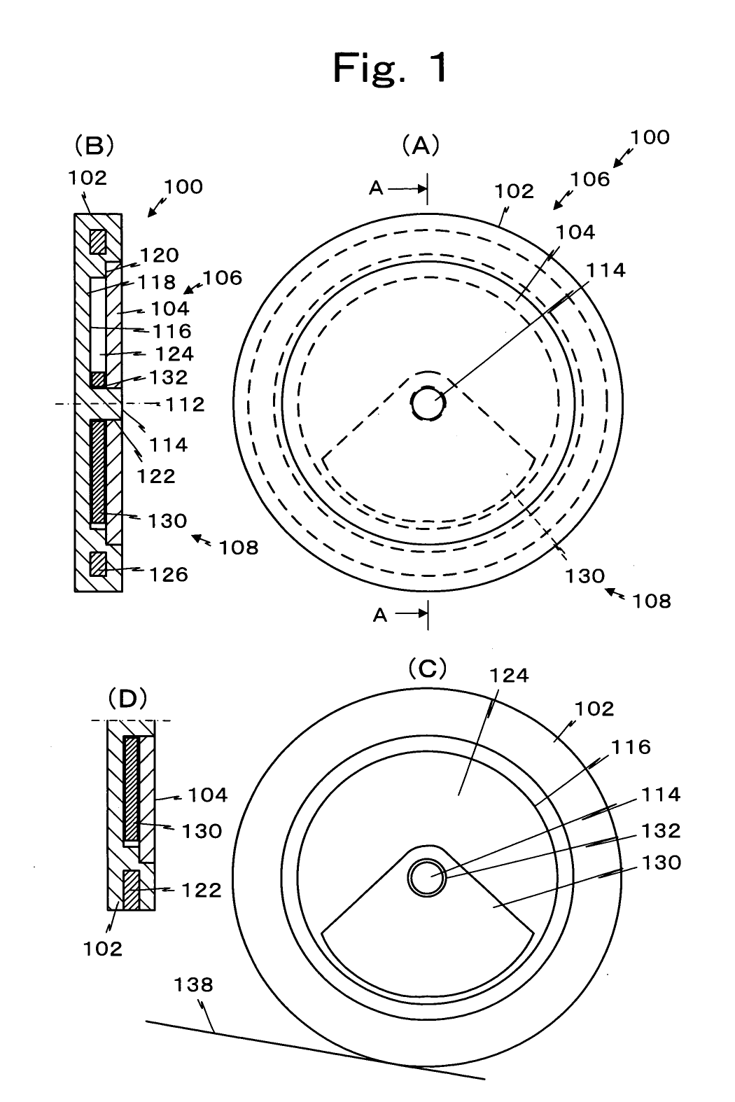

A first embodiment will be explained with reference to FIG. 1(A) to FIG. 1(D). FIG. 1(A) is a front view of a token according to the first embodiment, FIG. 1(B) is a cross sectional view along the line A-A in FIG. 1(A), FIG. 1(C) is a front view of the token of the first embodiment in which a second main body is removed, and FIG. 1(D) is a sectional view of another example of a ring in the first embodiment.

A token 100 of the present embodiment includes a token main body 106 including a dish-like or round cylinder first main body 102 and a second main body 104 serving as a lid or cover for the first main body 102, and a non-contact sensing object 108 mounted in the main body 102. The first main body 102 is a disc-like member molded by injection of an appropriate resin having the desired wear characteristics such as a polymide with glass beads. The main body 102 has a cylindrical spindle 114 and a circular ring recess 116 on the periphery of the spindle 114 which are formed coaxially about an axial line 112. In other words, a lateral wall 118 of the first main body 102 constitutes a bottom wall of the recess 116.

The second main body or cover member 104 is a disc formed by the molding of the same type of resin as that for the first main body 102. The second main body 104 is inserted into a circular step 120 formed on the periphery of the recess 116, and may be integrated with the first main body 102 by adhesion or by welding. A distal end of the spindle 114 is inserted into a circular hole 122 formed in the center of the second main body 104, and fixed by adhesion or fusion. As a result, the second main body 104 and the lateral wall 118 of the first main body 102 are integrated and enhanced.

The token 100 has a thin ring-shaped path 124 centered about an axial line 112, and defined by the recess 116 and the second main body 104. Preferably, the recess 116 has an outer circumference in which a non-contact sensible ring 126 can be embedded. By forming the non-contact sensible ring 126 of metal having a high specific gravity, the token 100 gains additional weight, resulting in that the token 100 has a luxurious feel of significant weight when a user handles the token. Additionally, by forming the token main body 106 of a resin, the token looks like an IC token incorporating an IC tag. This can be psychologically effective for suppressing unauthorized use.

Preferably, the non-contact sensible ring 126 is made of a relatively inexpensive material such as iron, brass, copper, zinc and the like at low cost by a punching press process. In addition, since the thickness of the token 100 is at most about 4 millimeters, the thicknesses of the lateral wall 118 of the first main body 102 and the second main body 104 that define the path 124 cannot be made thick. Accordingly the token 100 can be relatively weak against any external force exerted circumferentially of the token 100.

However, by strategically arranging the location of the non-contact sensible ring 126, any external force will be further supported by the non-contact sensible ring 126 to provide excellent strength to the token, so that it is possible to improve the strength and endurance. Since the resultant strength of the token 100 is large, an advantage arises in that the token 100 may be dispensed mechanically.

Furthermore, by sensing the existence of the non-contact sensible ring 126 with a non-contact sensor unit, or sensing the material or the like of the non-contact sensible ring 126, the sensing results may be utilized for determination of the real/fake status of the token. Therefore, an advantage arises in that design variations of the token 100 can be increased by varying the presence/absence of the non-contact sensible ring 126 and by varying the material of the non-contact sensible ring 126. The non-contact sensible ring 126 need not be covered on its entire circumference with resin as shown in FIG. 1 (D), but its outer circumference could be exposed.

Next, the non-contact sensing object 108 will be explained. The non-contact sensing object 108 is an entity representing a characteristic of the token 100, and the characteristic can be sensed by a non-contact sensor unit 408 as will be described later, and a real/fake status can be determined based on this characteristic.

The non-contact sensing object 108 is formed, for example, from a metal plate of different material, and a real/fake status can be determined by examining a characteristic of the material and comparing the characteristics with pre-stored values representative of a valid token.

Preferably, the non-contact sensing object 108 is formed of a material which is relatively inexpensive and large in specific gravity, for example, a metal plate of iron or the like by a punching press process. This makes it possible to massively produce the non-contact sensing object 108 at a relatively low cost, and hence to produce the token 100 at low cost. As the material for the non-contact sensing object 108, brasses, copper, white copper, nickel and stainless steel, as well as iron are suited for use because of their availability, large specific gravity, and relatively low cost.

The material of the non-contact sensing object 108 may be, for example, a plate formed by solidifying magnetic powder by baking, without being limited to metal. A profile such as width of the non-contact sensing object 108 may be sensed as a characteristic. The non-contact sensing object 108 should have a characteristic that can be sensed in non-contact manner. Accordingly, the kind of token 100 is determined based on the kind of material, shape and the like of the non-contact sensing object 108.

In the first embodiment, the non-contact sensing object 108 is a non-contact sensible rotor 130. The non-contact sensible rotor 130 is formed of brass, and shaped into a sector for movement in the path 124. By inserting a spindle 114 into a circular shaft hole 132 punched in the apex of the sector, the non-contact sensible rotor 130 is allowed to rotate about the spindle 114 in the recess 116.

In other words, the non-contact sensible rotor 130 is movable in the ring-shaped path 124 based on the gravity. When the token main body 106 rolls, the non-contact sensible rotor 130 can be kept in a pending state by its own weight.

When the token main body 106 rolls on a guide rail 138, the non-contact sensible rotor 130 receives via the shaft hole 132, a rotating force directed in one direction by a friction contact with the spindle 114, and receives a rotating force directed in a direction opposite to the one direction. Therefore, the non-contact sensible rotor 130 swings within a predetermined angle about the spindle 114, however, it keeps an almost stationary state relative predetermined position above the guide rail.

By arranging the non-contact sensor unit 408 opposite to the stationary position, a characteristic such as the type of material or the like of the non-contact sensible rotor 13 can be sensed. Furthermore, by making the first main body 102 and the second main body 104 opaque, the actual non-contact sensing object 108 cannot be viewed, so that an anti-counterfeiting effect is enhanced.

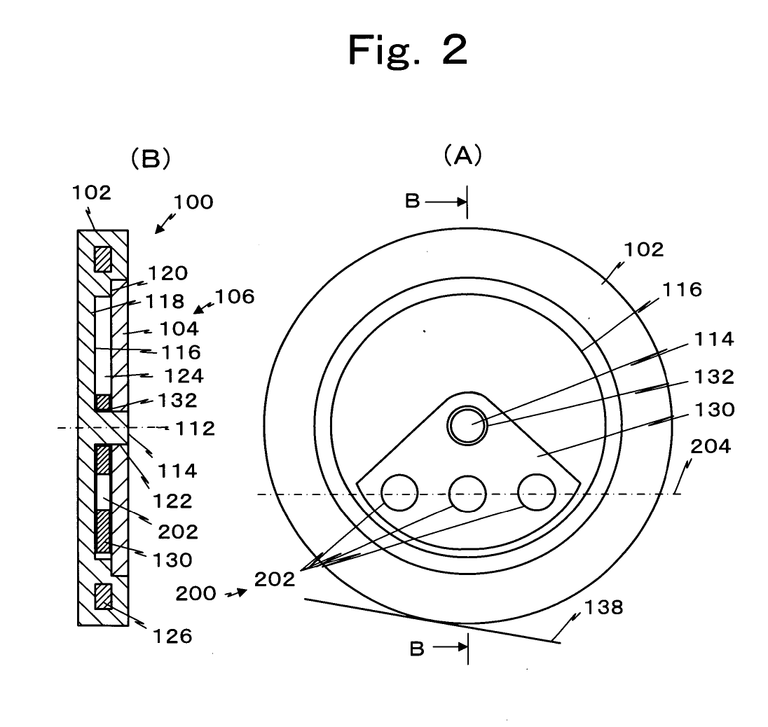

A second embodiment will be explained with reference to FIG. 2. FIG. 2(A) is a front view of a token of the second embodiment from which a second main body has been removed. FIG. 2(B) is a cross section view along the line B-B in FIG. 2(A).

The second embodiment incorporated on the non-contact sensing object 108 of the first embodiment except that a characteristic part 200 has been added. The characteristic part 200 serves to represent a characteristic other than characteristics given by the non-contact sensing object 108 itself. Concrete examples of the characteristic part 200 can include punching holes, engraved characters or symbols, printed characters or symbols on the non-contact sensing object 108, and foreign materials and the like embedded in the non-contact sensing object 108.

As an illustration of one example of the characteristic part 200 in the second embodiment, three circular through-holes 202 can be provided. Actually, the through-holes 202 could be limited to at least one hole, and their shape need not be limited to circular.

When the through-holes 202 are punched to provide a plurality of holes, the through-holes 202 can be arranged on a straight line 204 so that distances from the guide rail 138 to all the through-holes 202 are equal for enabling detection by a single non-contact sensor 408 as shown in FIG. 2(A).

Therefore, the characteristic part 200 may be used in addition to characteristics of the non-contact sensing object 108 itself for determining whether the token is real or fake, so that it is possible to increase the variations in design of the non-contact sensing object 108, namely of the token 100.

When the token main body 106 rolls across the guide rail 138, the non-contact sensing object 108, namely the non-contact rotor 130 swings a certain predetermined amount with respect to the spindle 114 as described above and the through-holes 202 can be sensed without any influence of the swing.

For this reason, the length in the swinging direction of the through-hole 202, namely the diameter of the through-hole 202 is set to be larger than the effect of the swinging amount. Furthermore, when a plurality of through-holes 202 are provided, as in the second embodiment, the interval between these through-holes 202 is set to be larger than the swinging amount.

When the characteristic part 200 is implemented by the through holes 202 as in this embodiment, the holes may be punched in the same punching process for the non-contact sensible rotor 130, so that an advantage of double production steps at a low cost is achieved.

When the characteristic part 200 is implemented by engraved or printed characters or symbols, it should be able to recognize by an image processing procedure through the resin of the token main body 106. In such a case, it is necessary for the first main body 102 and the second main body 104 to be molded with resins that permit passage of non-visible light but not visible light, for example, with acrylic resins, epoxy resins and the like visible light cutting resins.

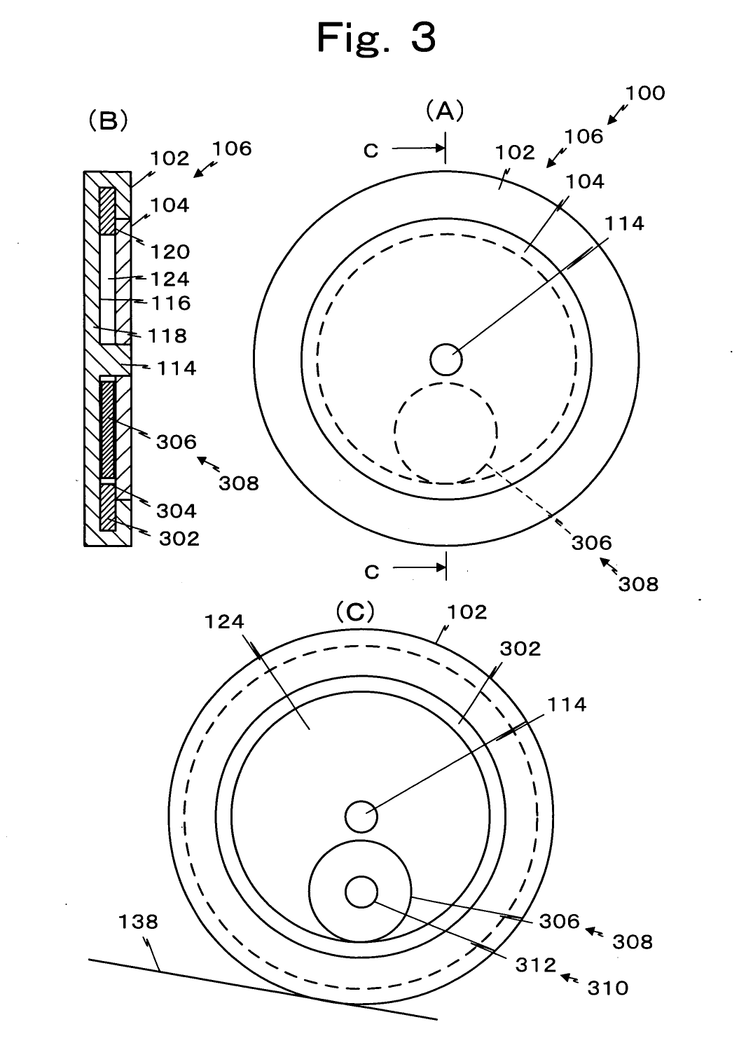

Next, a third embodiment will be explained with reference to FIG. 3. FIG. 3(A) is a front view of a token according to the third embodiment, FIG. 3(B) is a section view along the line C-C in FIG. 3(A), and FIG. 3(C) is a front view of the token according to the third embodiment in which the second main body is removed for ease of illustration. The elements equivalent to those in the first embodiment will be denoted by the same reference numerals, and explanation thereof will be omitted. Explanation will be given only for the different configuration.

An inner circumferential surface 304 of a non-contact sensing ring 302 is not covered with a resin, but forms an outer circumferential surface of the recess 116.

Therefore, the step 120 is formed by the non-contact sensible ring 302 and the first main body 102, and the path 124 is defined by the inner circumferential surface 304 of the non-contact sensible ring 126, the lateral wall 118, and the second main body 104. In the path 124, a non-contact sensing object 308 of a cylindrical disc shape which is a non-contact sensible roller 306 is mounted in a movable manner.

The non-contact sensing object 308 can be a disc-like plate which is formed from a metal sheet as is the case with the first embodiment. Since the diameter of the non-contact sensing object 308 is smaller than the distance between the inner circumferential surface 304 and the outer circumferential face of the spindle 114 and thinner than the thickness of the path 124, it can freely travel across the path 124 by its own weight.

When the strength of the lateral wall 118 and the second main body 104 are sufficiently large, the spindle 114 need not be provided. In this case, the path 124 will be a disc shape rather than ring shape, but even with this disc shape, it still embraces the scope of the ring-shaped path of the present invention.

The non-contact sensing object 308 may be further supplemented with a characteristic part 310. The characteristic part 310 can be implemented by one or more thorough holes 312, characters, symbols and the like as is the case with the first embodiment.

When the token main body 106 rolls on the guide rail 138, the non-contact sensing object 308 is brought into a condition that it is located on a slant surface by rolling on the inner circumferential surface 304 of the non-contact sensible ring 302. The non-contact sensing object 208 rolls down by its own weight on the slant surface, and tends to remain relatively stationary at a lowermost position as a result of gravity and a low frictional interface between the sensing object 308 and the surface 304. Therefore, the non-contact sensing object 208 rotates in a position where the rolling force and the stationary force by the inner circumferential surface 304 are almost in balance.

By positioning a non-contact sensor at a position along the guide rail for the non-contact sensing object so as to be opposite to the balanced position, it is possible to sense a characteristic of the non-contact sensing object 308.

The characteristic of the non-contact sensing object 308 can be one or more of material type and, size and number of the non-contact sensing object 308. Also, the existence of a characteristic part 312, size of the characteristic part 312, number and the like of the characteristic part 312, and their combination may be combined for determining whether a token is real or fake. Therefore, by combining these characteristics of the non-contact sensing object 308 and the characteristic part 310, it is possible to increase the variations of creating pattern signals of tokens 100.

By sticking a printed seal on the exterior of the lateral wall 118 and an exterior of the lateral face of the second main body 104, it is possible to improve the appearance of the token 100 to the user.

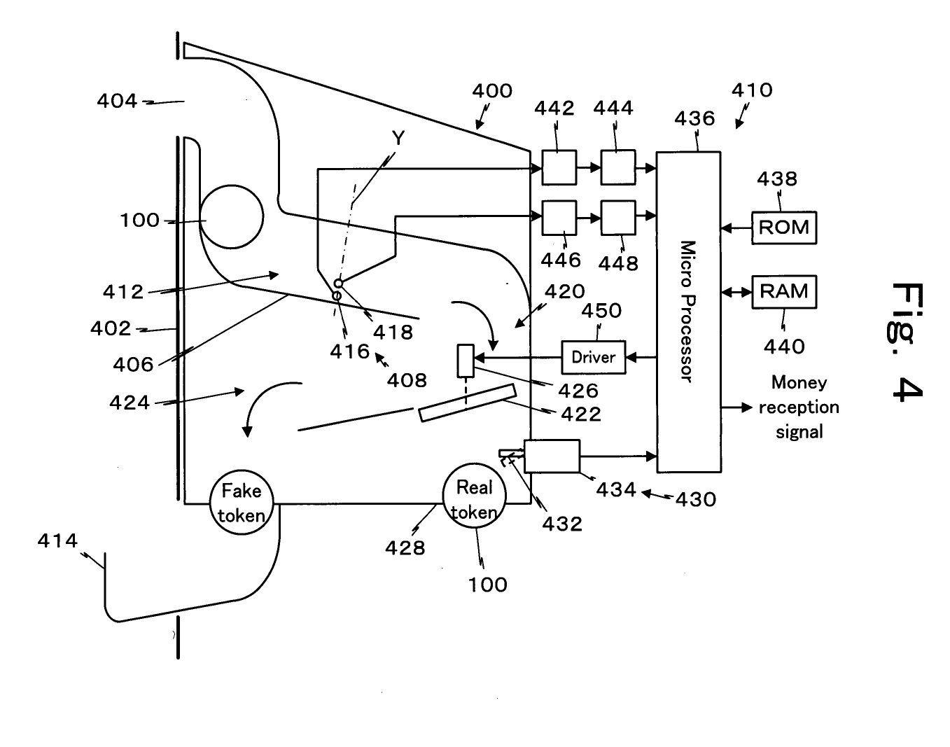

Next, a separator assembly 400 for these tokens 100 will be explained with reference to FIG. 4. FIG. 4 is a schematic view of a token separator for the first to third embodiments.

The separator 400 can be incorporated, for example, in a game machine 402. The separator 400 includes a token slot 404, a guide rail 406 on which a token 100 inserted through the slot 404 rolls, a non-contact sensor unit 408 disposed along the guide rail 406, and a determiner unit 410 for determining whether the token is real or fake based on an output from the non-contact sensor 408.

First, the slot 404 will be explained. On a front face of the separator 400, a slot 404 having a longitudinal slit shape is formed. The longitudinal dimension of the slot 404 is slightly larger than the diameter of the token 100, and the width of the slot 404 is formed to be slightly larger than the thickness of the token 100. Therefore, a token of a size larger than the diameter or width of the real token 100 cannot be slotted into the slot 404.

Sequentially from the slot 400, a slant path 412 is formed that extends in a direction leaving from the slot 404. The slant path 412 is formed by a downwardly inclined guide rail 406 which declines in the downstream side.

On both sides of the downwardly-inclined guide rail 406, guiding lateral walls (not shown) are disposed at an interval which is slightly larger than the width of the token 100. One of these guiding lateral walls can be movable such that it enlarges the slant path 412 for returning a jammed token 100 to a return slot 414. Therefore, the token 100 rolls on the guide rail 406 while its lateral face is guided by the guiding lateral walls in the slant path 412.

Next, a non-contact sensor unit 408 will be explained. The non-contact sensor unit 408 having a function of detecting a characteristic of the token 100, is disposed so as to be opposite to the slant path 412 and fixed to the guiding lateral wall. The non-contact sensor unit 408 includes a first sensor 416 for sensing characteristics of the rings 126, 302, and a second sensor 418 for sensing characteristics of the non-contact sensing objects 108, 308.

A first sensor 416 has a function of sensing the materials of the rings 126, 302. The first sensor 416 can be implemented, for example, by a coil, and disposed so as to be opposite to the lateral faces of the rings 126, 302. A second sensor 418 is attached on a lateral wall which is farther from the guide rail 406 than the first sensor 416 in the slant path 412.

Similar to the first sensor 416, the second sensor 418 is implemented, for example, by a coil, and is disposed to be opposite to the lateral faces of the non-contact sensing objects 108, 308. Thus, the first sensor 416 and the second sensor 418 are located on the line Y that is orthogonal to the guide rail 406.

Downstream of the slant path 412, a sorting path 420 extending in a vertical direction is provided, and a sorting gate 422 is disposed in the path 442. The sorting gate 422 protrudes into the sorting path 420 usually by a spring (not shown). Therefore, fake coins or tokens of different game spaces dropping from the slant path 412 are guided to a return path 424 by the sorting gate 422 and returned to the return slot 414.

When a real token 100 exits the sorting path 420 by the gate 422 due to excitation of a solenoid 426, it drops into a receiving slot 428 and is pooled in a pooling or collecting part (not shown).

In the course of dropping into the receiving slot 428, the token 100 is detected by a reception sensor 430. The reception sensor 430 is implemented, for example, by a micro switch 434 whose contact piece 432 is pushed by the token 100.

Next, the determiner unit 410 will be explained. The determiner unit 410 can be a micro processor 436 which has appropriately written data information in a RAM 440 according to a program stored in a ROM 438, and executes a predetermined processing while reading out the same.

To be more specific, the second sensor unit 418 will provide output signals concerning materials and the like of the non-contact sensing objects 108, 308, and the existences and sizes of characteristic parts 200, 310 may be obtained via an oscillating circuit 446 and A/D converting circuit 448. From the first sensor 416, signals concerning characteristics of material of the rings 126, 302 can be obtained via an oscillating circuit 442 and an A/D converting circuit 444.

Therefore, these signals representative of pre-determined characteristics are compared with predetermined references values stored in the micro processor 435 for determining whether the token is real or fake. If a signal selected from these characteristics is real, or if all of selected plural characteristics are real, the token is determined as real.

When it is determined that the token 100 is real, the solenoid 426 is excited for a predetermined time period by a driver 450 and the gate 422 is exited from the sorting path 210 and, therefore, the token 100 drops into the receiving slot 428. The token 100 contacts and shifts a contact piece 432 in the course of this dropping action, and a money reception signal is outputted to the game machine 402 to make ready for the starting of a game.

When the token 100 is determined to be unauthenticated or fake, the solenoid 426 is not excited, so that the gate 422 is kept in a state of protruding into the sorting path 420. Hence, the fake token 100 is guided through the returning path 424 to the returning slot 414.

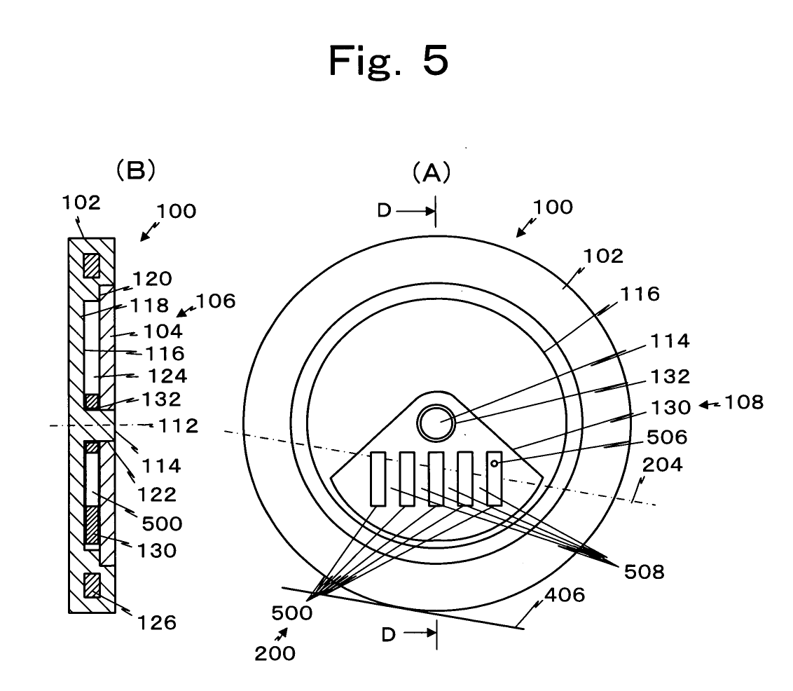

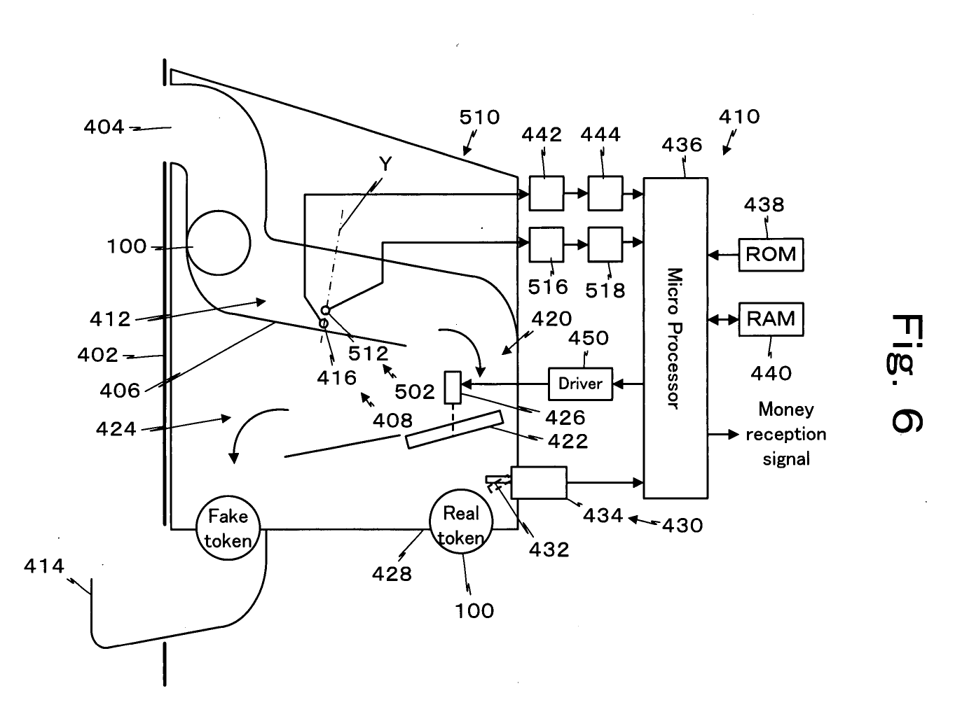

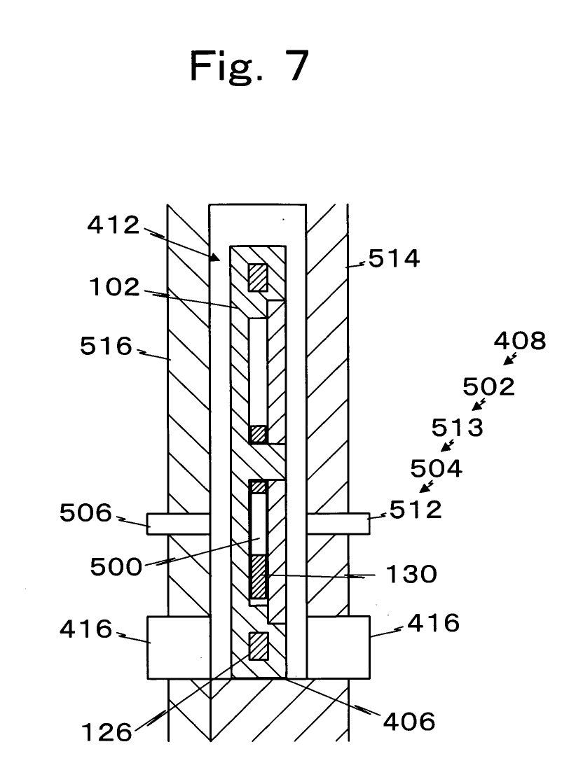

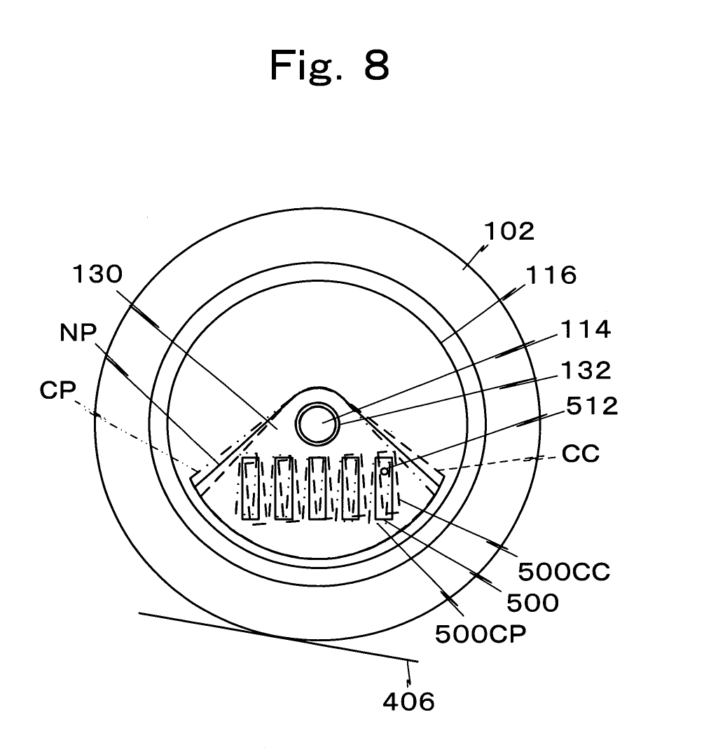

Next, a fourth embodiment will be explained with reference to FIGS. 5 to 8. FIG. 5(A) is a front view of a token according to the fourth embodiment in a state that the second main body is removed, and FIG. 5(B) is a section view along the line D-D in FIG. 5(A). FIG. 6 is a schematic view of a token separator according to the fourth embodiment. FIG. 7 is a section view along the line Y in FIG. 6. FIG. 8 is an explanatory view for operation of the fourth embodiment.

In the fourth embodiment, the characteristic part 200 of the non-contact sensing object 108 of the second embodiment is replaced by one or more slits 500, and the non-contact sensor 408 is changed to an optical sensor 502, more specifically, a laser transmissive sensor 504.

First, the slit 500 which is a characteristic part of the fourth embodiment will be explained. The non-contact rotor 130 which is capable of being sensed by a sensor is provided with a plurality of vertically extending rectangular slits 500 that are equally spaced in parallel and narrow in width, as a substitute for the circular through-holes 202 in the second embodiment.

The slits 500 are partitioned by a light shielding wall 508. The width of the slit 500 is so selected that an opening larger than the width of the light bundle in the optical sensor 502 is formed in the slit 500 even when the non-contact sensible rotor 130 swings as is to be expected in the normal course of rolling of the token 100 on a guide rail 406 with a predetermined sloping surface. In other words, the width is selected so that an opening which is larger than the width of a light bundle from a projector 506 is formed for one slit 500 even when the non-contact sensible rotor 130 may swing or oscillate during the rolling of the token. Preferably, the width of the light shielding wall 508 is selected as small as possible. Specifically, it has a width which is equivalent to the width of the light projected from the projector 506.

With this configuration, even when the non-contact sensible rotor 130 moves while swinging right and left as if it is a pendulum, an opening corresponding to the slit 500 is securely formed for purposes of monitoring at a predetermined location, and a wall corresponding to the light shielding wall 508 is formed.

Next, a separator assembly 510 which is suited for the token 100 of the fourth embodiment will be explained with reference to FIGS. 6 and 7. Similar elements as those in FIG. 4 are denoted by the same reference numerals and explanation thereof will be omitted. Explanation will be given only for the different configurations.

The optical sensor 502 is disposed in a position corresponding to that of the second sensor 418. In other words, it is located at a position opposite to where the slit 500 formed in the non-contact sensible rotor 130 will pass on the guide rail 406 when the token 100 rolls on the guide rail 406. The optical sensor 502 includes the projector 506 and a light receiver 512 disposed to face each other while the guide rail 406 is interposed therebetween. In other words, the projector 506 and the light receiver 512 constitute a transmissive optical sensor 513 disposed to face each other while the slant path 412 is interposed therebetween.

To be more specific, the light receiver 512 is fixed to a stationary guiding lateral wall 514 constituting the slant path 412, and the projector 506 is fixed to a movable guiding lateral wall 516 disposed parallel with the stationary guiding lateral wall 514 at a certain interval.

The projector 506 is preferably implemented by a laser projector where a width (diameter) of a light bundle can be reduced. Output from the light receiver 512 is converted from analogue to digital by the AD converting circuit 516, and compared in the subsequent comparing circuit 518 with a predetermined reference value. If the received light amount is more than or equal to a predetermined value, a signal H, namely a light reception signal representing that light having transmitted the slit 500 is received, is outputted, whereas if it is less than or equal to the predetermined value, a signal L, namely a light shield signal representing that light is not received is outputted.

Next, an operation of the fourth embodiment will be explained. When the token 100 rolls on the guide rail 406, the non-contact sensible rotor 130 receives a clockwise rotating force as shown in FIG. 8 as a result of the friction between the spindle 114 and the shaft hole 132. As a result, the non-contact sensible rotor 130 moves from a normal position NP in a stationary state to a position CP by rotating in a clockwise direction, while the slit 500 moves to a position 500C shown by the double dotted broken line.

When the non-contact sensible rotor 130 is located at the position CP, the counterclockwise rotating force by the gravity is larger than the clockwise rotating force by the friction, so that the non-contact sensible rotor 130 rotates in a counterclockwise direction to reach a double dotted broken line CC, while the slit 500 rotates to a position 500CC shown by a broken line.

When the non-contact sensible rotor 130 is located at the position CC, the clockwise rotating force by the friction between the spindle 114 and the shaft hole 132 is larger than the counterclockwise rotating force provided by gravity, so that the non-contact sensible rotor 130 rotates in the clockwise direction as described above. The non-contact sensible rotor 130 swings or oscillates generally between the positions CP and CC in a repetitive and predictable manner, while the token 100 rolls at a constant speed.

A light bundle from the projector 506 is securely received by the light receiver 512 at every passage of slit 500 because it is located at a position where the swinging positions 500CP and 50OCC of the slit 500 overlap with each other.

When the light receiver 512 receives light, output therefrom is converted into a digital signal by the AD converting circuit 512, and then compared with a reference value in the comparing circuit 518. The comparing circuit 518 outputs a light reception signal H because the received light amount is larger than the reference value. Therefore, the micro processor 436 determines the number of light reception signals H from the comparing circuit 518 to identify the variations of the token 100. In other words, the kind of the token 100 is identified from the number of light reception signals based on the number of the slits 500.

In particular, when a laser beam from the projector 506 is used, the width of the light bundle can be made very small, so that it is possible to punch an increased number of slits 500 into a limited size area of the non-contact sensible rotor 130. This offers an advantage in that variations of tokens 100 can be increased because more characteristic parts 200 can be created.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A token of a disc shape, comprising
a token main body having a ring-shaped path formed therein; and
a non-contact sensing object disposed in the ring-shaped path, capable of moving based on gravity.

2. The token according to claim 1, wherein said non-contact sensing object has a characteristic part that can be sensed by a sensor.

3. The token according to claim 2, wherein said characteristic part is a through-hole.

4. The token according to claim 1, wherein on an outer circumference of said ring-shaped path, a non-contact sensible ring is disposed.

5. The token according to claim 1, wherein said non-contact sensing object is a non-contact sensible roller capable of rolling on said ring-shaped path.

6. The token according to claim 1, wherein said non-contact sensing object is a non-contact sensible rotor which is movable relative to a spindle located in the center of said token.

7. The token according to claim 5, wherein said non-contact sensible roller is made of metal.

8. The token according to claim 6, wherein said non-contact sensible rotor is made of metal.

9. A token separator assembly for a token having a non-contact sensing object relatively movable within a token body comprising:
a housing having a slot through which a token is inserted;
a guide rail on which the token inserted through the slot will roll having an inclined surface to enable the token body to rotate about the non-contact sensing object;
a non-contact sensor disposed along said guide rail to sense the non-contact sensing object; and
a determiner unit for determining whether the token based on an output from said non-contact sensor is real or fake.

10. The token separator assembly according to claim 9, wherein said non-contact sensor is an optical sensor.

11. The token separator assembly according to claim 10, wherein said non-contact sensor includes a light projector and a light receiver disposed to face each other, with said guide rail interposed therebetween for translating said token.

12. A token comprising:
a body member configured to move relative to a support surface and having an opening therein; and
a sensing object movably mounted within the opening wherein the body member can relatively revolve around the sensing object as the body member translates across a support surface.

13. The token of claim 12 wherein the sensing object is pivotally mounted within the opening at a location substantially at a center of the body member.

14. The token of claim 13 wherein the sensing object increases in width, from the pivotal mounting, at a position radially offset from the pivotal mounting.

15. The token of claim 13 wherein at least one opening is provided in the sensing object.

16. The token of claim 12 wherein the sensing object is freely mounted within the opening and configured for rotation, by gravity pull, within the opening as the body member translates across the support surface.

17. The token of claim 16 wherein the sensing object is configured as a cylindrical disc for rotation within the opening.

18. The token of claim 17 wherein the sensing object includes at least one opening extending through the cylindrical disc.

19. The token of claim 12 wherein the body member is formed of a plastic resin and a metal ring member, attached to the body member, extends around the opening.

20. The token of claim 12 wherein the sensing object is formed of a plastic resin and a metal member is embedded in the sensing object.
